(19) United States
(12) Patent Application Publication
(10) Pub. No.: US 2014/0001336 A1
(43) Pub. Date: Jan. 2, 2014

(54) SOLAR POWERED RADIO FREQUENCY TRANSMITTER

(71) Applicant: Richard A. Leinen, Wilsonville, OR (US)

(72) Inventor: Richard A. Leinen, Wilsonville, OR (US)

(73) Assignee: Leviton Manufacturing Co., Inc., Melville, NY (US)

(21) Appl. No.: 13/534,346

(22) Filed: Jun. 27, 2012

(51) Int. Cl. H01J 40/14

(52) U.S. Cl. 250/206

(57) ABSTRACT

An assembly includes a solar cell to convert light into electric power, a radio frequency (RF) transmitter to convert electric power from the solar cell to RF energy and transmit the RF energy, and a mounting interface to mount the assembly to a window or transparent surface, wherein the solar cell is oriented to receive the light through the window or transparent surface. The transmitted RF energy may be adequate to power one or more RF self-powered devices and/or may include light level information. The light level information may include a measure of the light entering through the window and/or available light in a space of the building. The light level information may be implemented as an ON/OFF signal or a measure of the light level.

### BACKGROUND

FIG. 1 illustrates a prior art self-powered wireless light sensor. The sensor 10 is within a housing 12 that is mounted to a ceiling or wall surface 14. Two photovoltaic (PV) solar cells 16 are arranged on opposite sides of the housing 12 to convert ambient light into electric power to operate the sensor. A photocell 18 measures the amount of light available in the space in which the sensor is mounted. The electric power generated by the solar cells operates a microcontroller and transmitter that are located within the housing. The microcontroller takes periodic ambient light readings from the photocell and transmits RF signals to one or more wireless receivers based on the readings from the photocell.

The sensor can operate in two different modes, ON/OFF mode and light level mode. In ON/OFF mode, the sensor compares the readings from the photocell to a user defined threshold level and periodically transmits an ON or OFF signal to control a relay or other switching device having a wireless receiver that is paired with the sensor. Thus, the sensor and switching device can be arranged to turn on artificial lighting when the ambient light level falls below the threshold level.

In light level mode, the sensor periodically transmits a signal that indicates the light level measured by the photocell to a dimmer having a wireless receiver paired with the sensor. The dimmer can then use the light level to adjust the brightness of artificial lighting to supplement any ambient light available in the space in which the sensor is mounted.

### SUMMARY

Some inventive principles of this patent disclosure relate to a solar powered RF transmitter including a solar cell to convert light into electric power, a radio frequency (RF) transmitter to convert electric power from the solar cell to RF energy and transmit the RF energy, and a mounting interface to mount the assembly to a transparent surface, wherein the solar cell is oriented to receive the light through the transparent surface.

Some additional inventive principles of this patent disclosure relate to a method including receiving light through a window or transparent surface of a building, converting the light to electric energy using a solar cell mounted to the window, converting the electric energy to radio frequency (RF) energy, and transmitting the RF energy within the building.

Some further inventive principles of this patent disclosure relate to a system including an assembly comprising a solar cell to convert light into electric power, a radio frequency (RF) transmitter to convert electric power from the solar cell to RF energy and transmit the RF energy, and a mounting interface to mount the assembly to a window or transparent surface, wherein the solar cell is oriented to receive the light through the window or transparent surface, and a control device having a receiver to receive the RF energy from the assembly.

Some further inventive principles of this patent disclosure relate to a solar powered RF transmitter including a solar cell to convert light into electric power, a radio frequency (RF) transmitter to transmit light level measurements, wherein the RF transmitter is powered by electric power from the solar cell, and a mounting interface to mount the assembly to a transparent surface, wherein the solar cell is oriented to receive the light through the transparent surface.

### BRIEF DESCRIPTION OF THE DRAWINGS

FIG. 1 illustrates a prior art self-powered wireless light sensor.

FIG. 2 illustrates an embodiment of a solar powered radio frequency (RF) transmitter assembly according to some inventive principles of this patent disclosure.

FIG. 3 illustrates another embodiment of a solar powered RF transmitter assembly according to some inventive principles of this patent disclosure.

FIG. 4 illustrates another embodiment of a solar powered RF transmitter assembly according to some inventive principles of this patent disclosure.

FIG. 5 illustrates another embodiment of a solar powered RF transmitter assembly according to some inventive principles of this patent disclosure.

FIG. 6 illustrates another embodiment of a solar powered RF transmitter assembly according to some inventive principles of this patent disclosure.

FIG. 7 illustrates another embodiment of a solar powered RF transmitter assembly according to some inventive principles of this patent disclosure.

FIG. 8 illustrates an embodiment of a lighting control system having a solar powered RF transmitter assembly according to some inventive principles of this patent disclosure.

FIG. 9 illustrates another embodiment of a solar powered RF transmitter assembly according to some inventive principles of this patent disclosure.

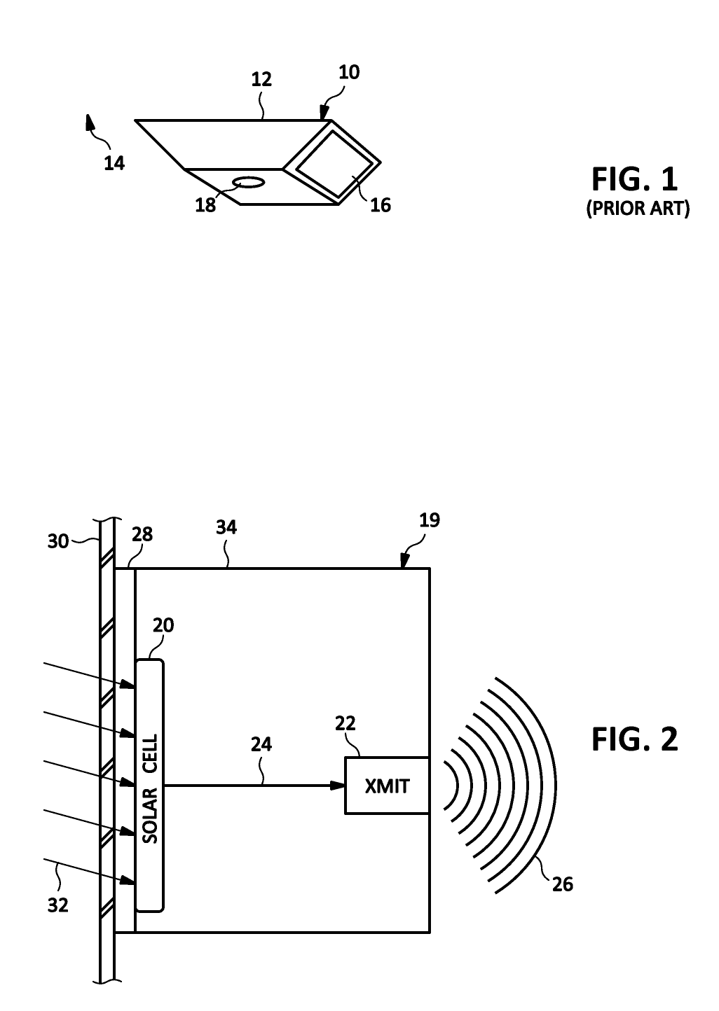

### DETAILED DESCRIPTION

FIG. 2 illustrates an embodiment of a solar powered radio frequency (RF) transmitter assembly according to some inventive principles of this patent disclosure. The assembly 19 of FIG. 2 includes a solar cell 20 to convert light into electric power, an RF transmitter 22 to convert electric power 24 from the solar cell 20 to RF energy 26 and transmit the RF energy. A mounting interface 28 mounts the assembly 19 to a window 30 or other transparent surface that is suitable to receive light therethrough, wherein the solar cell 20 is oriented to receive the light 32 through the window 30.

The assembly 19 of FIG. 2 may be enclosed in a housing 34. The housing 34 may be comprised of plastic or other suitable material. The mounting interface 28 may be implemented with any suitable apparatus such as, but not limited to, suction cups, removable or permanent adhesive, etc. For example, in some embodiments, a high-strength adhesive such as permanent two-sided pressure sensitive tape may be used to mount the housing 34 to the window 30. In other embodiments, relatively low-strength adhesives such as removable two-sided pressure sensitive tape or static cling vinyl film may be used. In yet other embodiments, hooks, chains or other mechanical fasteners may be used to attach the assembly or housing to a window frame, hang the assembly from window hardware, etc. In still other embodiments, a photocell may be included to provide a measure of visible light levels as described in more detail below.

The solar cell 20 may be realized with any suitable cell or array of cells including, but not limited to, monocrystalline silicon, polycrystalline silicon, etc. The transmitter 22 may be implemented with any suitable analog and/or digital transmitter hardware.

The embodiment of FIG. 2 may be constructed to operate in numerous modes according to the inventive principles of this patent disclosure. In one mode, the transmitter 22 may continuously transmit as much RF power as the solar cell 20 generates. The RF power transmitted in this manner may be used to power other devices such as RF powered wireless sensors that receive all or a portion of their operating power from the transmitter 22. Such an embodiment may be used to replace a conventional RF power transmitter that converts AC power from building wiring systems to RF power, thereby providing additional energy savings and reliability.

Alternatively, in this first mode of operation, the RF power transmitted by the embodiment of FIG. 2 may be used to provide a measure of the ambient light entering through the window. That is, since the electric power 24 available from the solar cell 20 varies as a function of the amount of light 32 striking the solar cell, and since the transmitter 22 continuously transmits as much RF power as the solar cell 20 generates, the strength of the RF signal received at a fixed distance from the transmitter 22 may be used as a measure of the ambient light entering through the window. To implement such a system, a wireless receiver may be positioned at a fixed distance from the assembly of FIG. 2 and calibrated by applying a light source with a known light output to the solar cell. The wireless receiver may optionally be powered by the RF energy 26 received from the transmitter 22. Thus, the RF power transmitted in this manner may be used to power other devices, and the strength of the RF signal may simultaneously be used to provide a measure of the ambient light entering through the window.

In other modes of operation, the transmitter 22 may be designed to limit the maximum RF output power. For example, the power may be limited to comply with Federal Communications Commission (FCC) or other agency rules, industry standards, etc. In yet other modes of operation, the transmitter 22 may be designed to transmit as much RF power as the solar cell 20 generates, but only intermittently. For example, the transmitter may transmit once every 30 or 60 seconds.

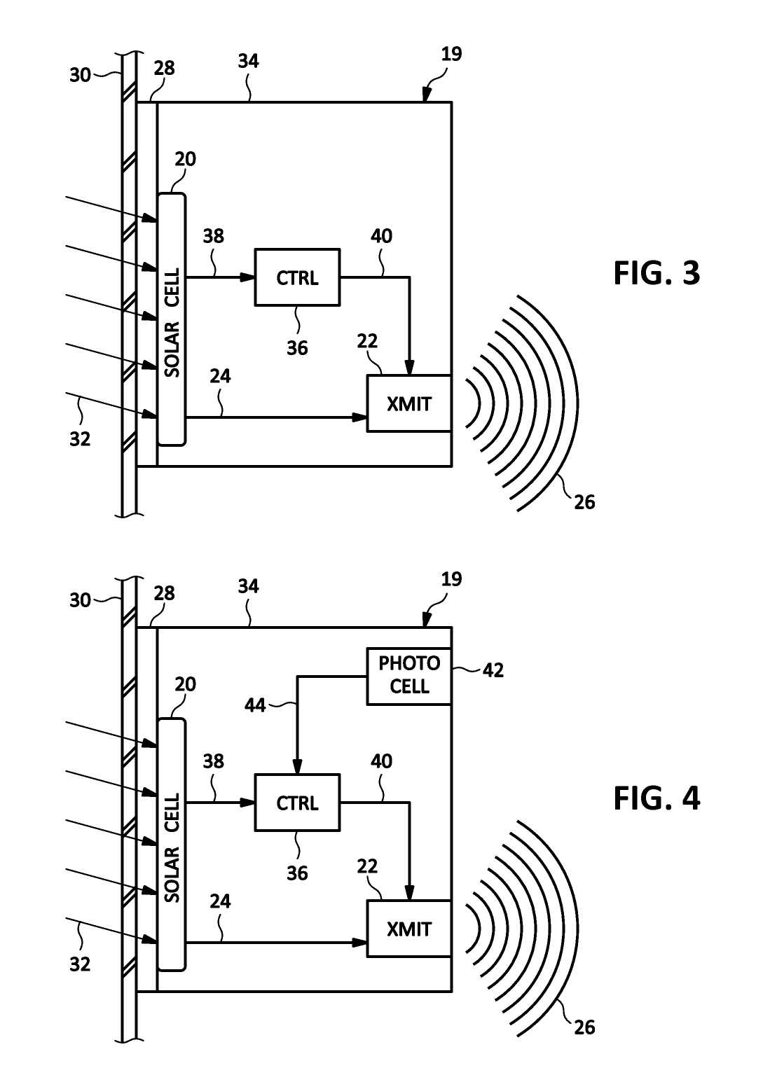

FIG. 3 illustrates another embodiment of a solar powered RF transmitter assembly according to some inventive principles of this patent disclosure. The embodiment of FIG. 3 is similar to that of FIG. 2, but includes a controller 36 arranged to receive electric power 38 from the solar cell 20 and generate one or more control signals 40 that are applied to the transmitter 22. The controller 36 may monitor one or more parameters of the solar cell 20, such as, but not limited to, the output voltage of the cell which in turn may provide a measure of the amount of light entering through the window. In one mode of operation, the controller 36 may convert the light measurement to a data signal that is modulated onto the RF carrier signal generated by the transmitter 22. This enables a wireless receiver on a dimmer, a building energy management system, a room controller, or other lighting or energy control apparatus to demodulate the data signal to receive a measure of the amount of light entering through the window.

In another mode of operation, the controller 36 may compare the light measurement to a threshold value and generate an ON/OFF control signal that is modulated onto the RF carrier signal generated by the transmitter 22. This modulated control signal may then be used by a relay or other switch, a building energy management system, a room controller, etc., to demodulate the ON/OFF signal to control lighting or other electrical loads.

In any of these modes of operation, the RF signal from the transmitter 22 may be used only for signaling or communication purposes, or it may also be used to provide all or some of the operational power to the receiving device.

The controller 36 may also provide other functionality to the assembly. For example, the controller may implement timing patterns to cause the transmitter 22 to transmit RF energy 26 at fixed or variable intervals. The controller may also store a unique identifier number (UID) or other serial number or identifying information and cause the transmitter 22 to transmit this identifying information on the RF output signal.

The controller may be implemented with any suitable analog and/or digital hardware, software, firmware or combination thereof. For example, the controller may be implemented with a low-power microcontroller that uses only a small percentage of the electric power generated by the solar cell.

FIG. 4 illustrates another embodiment of a solar powered RF transmitter assembly according to some inventive principles of this patent disclosure. The embodiment of FIG. 4 is similar to that of FIG. 3, but includes a photocell 42 arranged to sense available light in the space in which the assembly is mounted. In the example of FIG. 4, the photocell 42 is arranged to face in the opposite direction as the solar cell 20 to measure light originating within the space, rather than coming through the window 30. The photocell 42 generates a sensor signal 44 which may be converted into a data signal by the controller 36 and modulated onto the RF carrier signal generated by the transmitter 22. The measurement from the photocell 42 may be transmitted instead of, or in addition to, a measurement of the amount of light entering through the window provided by the solar cell 20. For example, the light level measurements from the photocell 42 and the solar cell 20 may be transmitted during different time slots or on different frequencies in the RF output signal.

As with the embodiment of FIG. 3, the measurement from the photocell 42 may be compared to one or more thresholds and transmitted as an ON/OFF signal and/or transmitted as a light level signal.

A benefit of the embodiment of FIG. 4 is that it may be used to implement closed loop and/or open loop lighting control from the same transmitter assembly. In general, light sensors that measure light originating from outside a building space are used to implement open loop control schemes, whereas light sensors that measure light originating from inside the building space are used to implement closed loop control schemes. Thus, if the embodiment of FIG. 4 is constructed to utilize the solar cell 20 for light level measurement as well as energy conversion, it may be used to implement open and/or closed loop control schemes from the same assembly.

In other embodiments, the photocell 42 may be replaced or supplemented with other types of sensors such as, but not limited to, temperature sensors, humidity sensors, occupancy sensors based on passive infrared (PR) radiation, ultrasonic (U/S) energy, etc.

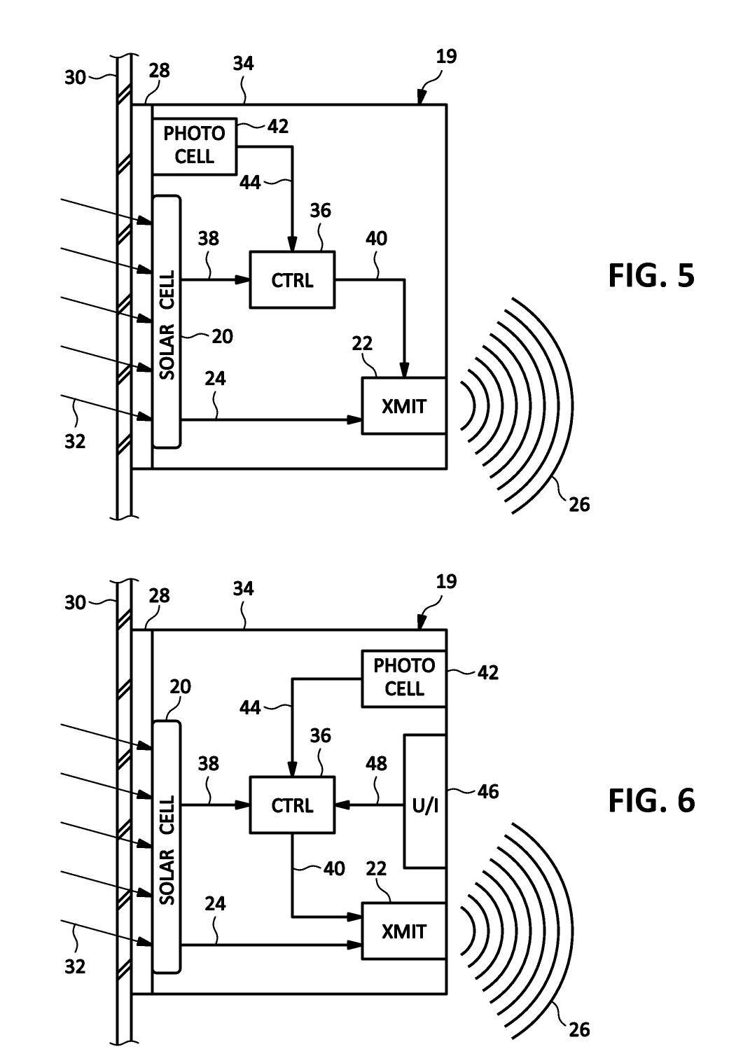

FIG. 5 illustrates another embodiment of a solar powered RF transmitter assembly according to some inventive principles of this patent disclosure. The embodiment of FIG. 5 is similar to that of FIG. 4, but the photocell 42 is moved to the window side of the assembly to provide a measure of the amount of light entering through the window. This enables the solar cell 20 to be used exclusively for generating electric power to operate the assembly. Though not shown in FIG. 5 one or more additional sensors such as another photocell may be included to sense light or other parameters of the space in which the assembly is mounted.

An advantage of using a photocell 42 that is separate from the solar cell 20 is that the photocell may be tailored to be sensitive to the same light wavelengths that the human eye is sensitive to, while the solar cell 20 may be tailored to convert the maximum amount of light entering through the window into electric power. Thus, the embodiment of FIG. 5 may provide more accuracy in determining illumination levels than may be achieved through use of the solar cell as a light level sensor.

FIG. 6 illustrates another embodiment of a solar powered RF transmitter assembly according to some inventive principles of this patent disclosure. The embodiment of FIG. 6 is similar to that of FIG. 4, but includes a user interface 46 to enable a user to input and receive information. For example, the user interface 46 may include a TEACH button to place the controller in a programming mode to pair the transmitter with one or more receiving devices. The user interface may also include a potentiometer, bank of switches, or other suitable device to input one or more thresholds for use during ON/OFF operation, to input calibration constants, etc. The user interface may further include a switch select between ON/OFF and level sensing modes of operation. Further inputs may include ON and OFF buttons for manual override or system testing operations.

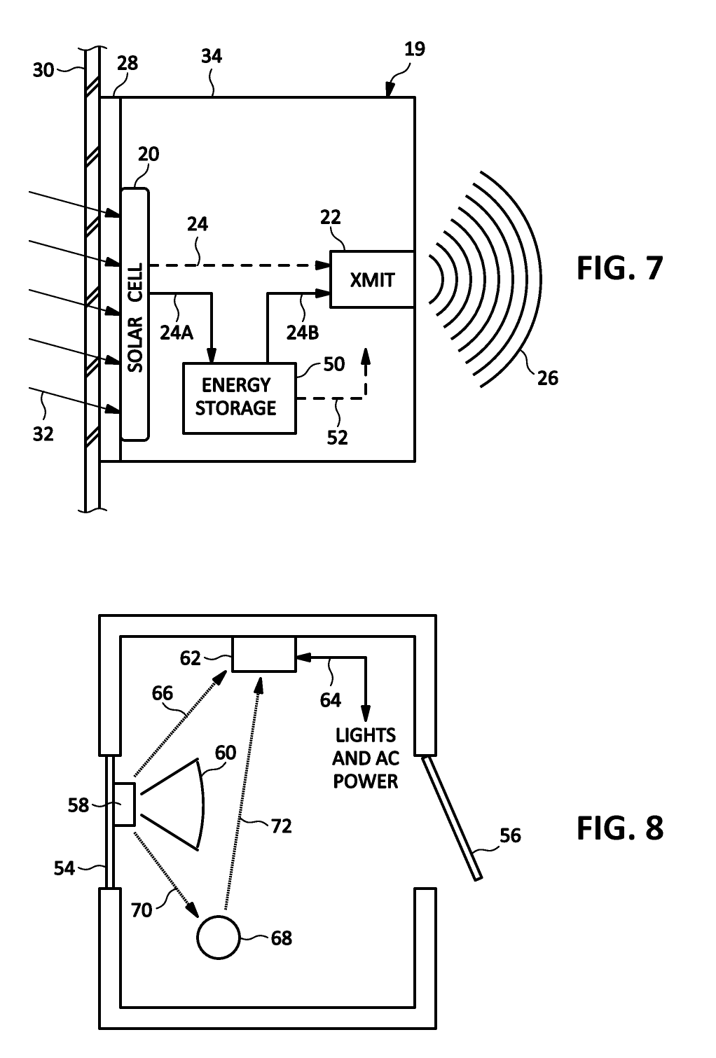

FIG. 7 illustrates another embodiment of a solar powered RF transmitter assembly according to some inventive principles of this patent disclosure. The embodiment of FIG. 7 includes one or more energy storage devices 50 to store and release electric energy 24A from the solar cell 20. The storage device 50 may be implemented with one or more batteries, capacitors, or any other suitable energy storage device. The storage device 50 may be connected as part of the power path between the solar cell 20 and the transmitter 22 as shown by the solid lines in 24A and 24B, as an alternative path to a main path shown as broken line 24, or in any other suitable configuration. An energy storage device may be used in conjunction with any of the embodiments shown in FIGS. 2-6 or any other embodiments according to the inventive principles of this patent disclosure, and energy stored at the storage device 50 may be used to power any other portion of the assembly as shown by broken line 52.

The energy storage device 50 may be used to store energy during the brightest daylight hours to enable the light sensor to operate overnight or at other times of day when there is not enough light entering through the window to power the assembly. The energy storage device 50 may also be used to store energy between transmissions if the transmitter is configured to transmit intermittently. This may enable the transmitter to operate at higher output powers for shorter periods of time compared to a continuous transmission scheme.

FIG. 8 illustrates an embodiment of a lighting control system having a solar powered RF transmitter assembly according to some inventive principles of this patent disclosure. The system of FIG. 8 is illustrated as a floor plan in the context of a room having an exterior window 54 and an interior door 56, but the inventive principles are not limited to this configuration. The system includes a solar powered RF transmitter assembly 58 similar to the embodiments illustrated with respect to FIGS. 4, 6 and 7. The assembly 58 is mounted to the window 54 and includes a photocell facing away from the window to provide a field of view 60 of available light in the room. All of the energy used by the assembly 58 is provided by a solar cell arranged to receive light entering through the window 54.

A room controller 62 is connected to building wiring 64 to receive AC power and control lighting and other electrical loads associated with the room. The room controller 62 receives an RF signal 66 from the transmitter assembly 58. Information including data from measurements of the amount of light entering the room through the window 54 as well as the available light within the room is modulated onto the RF signal 66. This information is demodulated by the room controller 62 and used to implement one or more open and/or closed loop daylight harvesting schemes and/or occupancy based lighting control schemes.

An RF self-powered occupancy sensor 68 operates using RF energy provided by the RF transmitter assembly 58. The RF energy is transmitted from the assembly 58 to the occupancy sensor 68 by RF signal 70, which may be the same as or separate from the RF signal 66. For example, energy may be transmitted on one frequency, while light level measurements may be transmitted on another frequency. The RF self-powered occupancy sensor 68 receives and stores the RF energy it receives from the RF transmitter assembly 58 to perform its occupancy sensing function, and transmit a wireless occupancy signal 72 to the room controller which uses the occupancy information to implement one or more open and/or closed loop daylight harvesting schemes and/or occupancy based lighting control schemes.

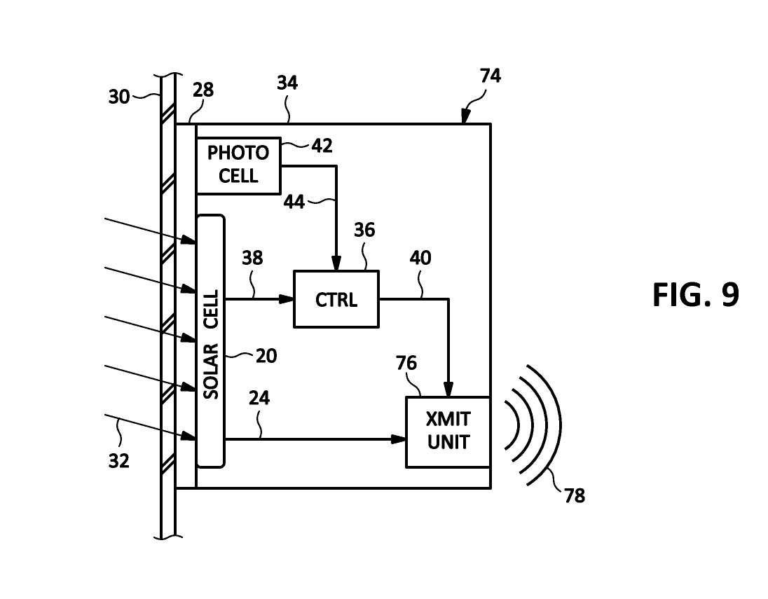

FIG. 9 illustrates another embodiment of a solar powered RF transmitter assembly 74 according to some inventive principles of this patent disclosure. The embodiment of FIG. 9 is somewhat similar to that of FIG. 5, but includes a transmit unit 76 that only transmits a generally lower power RF signal 78 that only provides light level information from the photocell 42 rather than providing power to other devices. For example, the transmit unit 76 may be implemented with the STM 100 transmitter module by EnOcean GMBH. This may enable the transmitter assembly 74 to operate with currently available wireless lighting control systems such as the the LevNet™ product line from Leviton, thereby enabling easy integration into existing systems while also providing enhanced features and convenience of installation.

The inventive principles of this patent disclosure enable the implementation of systems that are fast, simple, easy and inexpensive to install. These principles reduce the cost of installation by providing a more abundant source of power than could be harvested from solar cells on ceiling or wall mounted devices, while also eliminating the need for hard wiring an RF power transmitter to AC building wiring.

The inventive principles of this patent disclosure have been described above with reference to some specific example embodiments, but these embodiments can be modified in arrangement and detail without departing from the inventive concepts. Thus, any changes and modifications are considered to fall within the scope of the following claims.

1. A solar powered RF transmitter comprising:
a solar cell to convert light into electric power;
a radio frequency (RF) transmitter to convert electric power from the solar cell to RF energy and transmit the RF energy; and
a mounting interface to mount the assembly to a transparent surface, wherein the solar cell is oriented to receive the light through the transparent surface.

2. The solar powered RF transmitter of claim 1 wherein the transparent surface comprises a window.

3. The solar powered RF transmitter of claim 1 wherein the mounting interface comprises one or more suction cups.

4. The solar powered RF transmitter of claim 1 wherein the mounting interface comprises an adhesive material.

5. The solar powered RF transmitter of claim 4 wherein the mounting interface comprises a cling film.

6. The solar powered RF transmitter of claim 1 further comprising a sensor arranged to monitor a parameter of a building space having the transparent surface.

7. The solar powered RF transmitter of claim 6 wherein the sensor comprises a photocell.

8. The solar powered RF transmitter of claim 1 further comprising an energy storage device arranged to store electric power from the solar cell and provide power to the RF transmitter.

9. The solar powered RF transmitter of claim 1 further comprising a user interface to enable a user to configure the assembly.

10. The solar powered RF transmitter of claim 1 further comprising a controller arranged to receive electric power from the solar cell and control the operation of the RF transmitter.

11. A method comprising:
receiving light through a window or transparent surface of a building;
converting the light to electric energy using a solar cell mounted to the window;
converting the electric energy to radio frequency (RF) energy; and
transmitting the RF energy within the building.

12. The method of claim 11 wherein the transmitted RF energy powers one or more RF self-powered devices.

13. The method of claim 11 wherein the transmitted RF energy includes light level information.

14. The method of claim 13 wherein the light level information includes a measure of the light entering through the window or transparent surface.

15. The method of claim 14 further comprising using the solar cell to measure the light entering through the window or transparent surface.

16. The method of claim 13 wherein the light level information includes a measure of available light in a space of the building.

17. The method of claim 11 wherein the transmitted RF energy includes a device identifier.

18. A system comprising:
an assembly comprising a solar cell to convert light into electric power; a radio frequency (RF) transmitter to convert electric power from the solar cell to RF energy and transmit the RF energy; and a mounting interface to mount the assembly to a window or transparent surface, wherein the solar cell is oriented to receive the light through the window or transparent surface; and
a control device having a receiver to receive the RF energy from the assembly.

19. The system of claim 18 wherein:
the transmitted RF energy includes light level information measured at the assembly; and
the control device is constructed and arranged to control a lighting load in response to the light level information.

20. The system of claim 18 wherein:
the control device comprises an RF self-powered device; and
the transmitted RF energy is adequate to power the control device.

21. A solar powered RF transmitter comprising:
a solar cell to convert light into electric power;
a radio frequency (RF) transmitter to transmit light level measurements, wherein the RF transmitter is powered by electric power from the solar cell; and
a mounting interface to mount the assembly to a transparent surface, wherein the solar cell is oriented to receive the light through the transparent surface.

22. The solar powered RF transmitter of claim 21 further comprising a photocell to generate the light level measurements.

23. The solar powered RF transmitter of claim 21 wherein the light level measurements are obtained from the solar cell.
